(19) United States
(12) Patent Application Publication
(10) Pub. No.: US 2004/0250121 A1
(43) Pub. Date: Dec. 9, 2004

(54) Assessing security of information technology

(76) Inventor: Keith Millar, Cupertino, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/431,032

(22) Filed: May 6, 2003

(51) Int. Cl. H04L 9/00

(52) U.S. Cl. 713/201

(57) ABSTRACT

A method of assessing security of information technology. A list of security aspects is accessed. An information technology is assessed for each security aspect in the list.

### TECHNICAL FIELD

Embodiments of the present invention relate to assessing security of Information Technology.

### BACKGROUND ART

An on-going trend in information technology is the movement to “open” systems. An open information technology system typically comprises hardware and software from a wide variety of suppliers. There may be multiple operating systems. In addition, there may be hardware, e.g., routers, and software, e.g., computer aided design programs, used for similar tasks from different suppliers.

The widespread nature of the internet has broadened the accessibility of information technology systems. By coupling such systems via the internet, companies are able to reduce time to market and to reduce operating costs. Many companies are able to compete globally, even though they may not have a physical presence in many areas of the world.

However, such open systems are typically insecure. The hardware, operating systems and applications software, often from different suppliers, may have been designed with varying levels of security. Rarely, however, is that the same level of security. Even less frequently do such individual security features mesh effectively. Frequently, such individual security features are actually at odds with one another. Consequently, such open systems are often less secure than their individual component pieces.

Information technology security is critical to businesses. It protects business productivity and ensures customer confidence. In many cases, security is a regulatory requirement, e.g., for health care records. Increasingly, computer related crime is perpetrated by an insider, e.g., someone with approved access to a portion of the information system.

Many software and hardware suppliers, as well as information technology consultants, advertise “end-to-end” security. Typically, however, conventional systems focus in one of two areas. One area of focus is best described as “point-to-point” security. For example, a “point-to-point” security system may protect communications between a laptop computer system and a server computer system. A weakness of such systems is that the “points” are not the true “end points” of the business process; rather they are in reality intermediate points that are at each end of a network connection. However, they do not span to include the business applications, e.g. software programs or additional computer systems, that reside at each end.

A second area of security focus follows a layered model of solution architectures. Layered models would apply a series of defense mechanisms or “rings” around the information system. A castle analogy is frequently used to describe a layered security model. Open fields surround a moat, which surrounds thick, high walls, surrounding a highly secure castle “keep.”

Unfortunately, neither of these conventional approaches addresses the reality of the applications and business processes for which the information system is used. For example, the “moats” and “high walls” of a layered security system do little to protect against “insider” security violations, e.g., security violations by one already in the “keep.” Further, such existing systems often require an individual user to possess technical security expertise in order to use and employ the systems.

Thus a need exists for a method to assess information technology security. A further need exists to meet the previously identified need in a manner that is complimentary and compatible with conventional computer system management techniques.

### SUMMARY OF THE INVENTION

Embodiments of the present invention provide for a method to assess information technology security. Further embodiments of the present invention meet the previously identified need in a manner that is complimentary and compatible with conventional computer system management techniques.

A method of assessing security of information technology is disclosed. A list of security aspects is accessed. An information technology is assessed for each security aspect in the list.

### BRIEF DESCRIPTION OF THE DRAWINGS

FIG. 1 illustrates a flow diagram of a method of assessing security of information technology, in accordance with embodiments of the present invention.

FIG. 2 illustrates a chart of security aspects along with exemplary security technologies, in accordance with embodiments of the present invention.

### BEST MODES FOR CARRYING OUT THE INVENTION

A number of terms are widely used in the information security arts. “Privacy” is generally understood to refer to or to describe the ability of an information system (hardware, software or in combination) to control disclosure, transfer and/or modification of data. “Authentication” is generally understood to refer to or to describe the ability of a system to verify an identity. For example, the identity may be that of an individual user, a computer system, an application and/or a data set. It is to be appreciated that terms such as “authentication” may also be used as verbs to describe processes.

“Authorization” is generally understood to refer to the ability of an information system to grant permission, e.g., to access the system, based on an identity. “Data Integrity” is generally understood to refer to or to describe the ability of an information system to control modification and/or deletion of data. “Confidentiality” is generally understood to refer to or to describe the ability of an information system to limit information distribution to approved entities only.

“Non-repudiation” is generally understood to refer to or to describe the ability of an information system to document an event, e.g., a transfer of funds, in such a way that the occurrence of the event can not be denied. “Security audit” is generally understood to refer to or to describe a procedure to document events of an information system in a persistent record that can not be altered or deleted.

“Virus protection” is generally understood to refer to or to describe the ability of an information system to protect against, detect and recover from computer viruses. “Perimeter security” is generally understood to refer to or to describe features of an information system, e.g., hardware and/or software, that provide “fence-like” security. For example, perimeter security typically provides an “inside” and an “outside” or “in-front” and “behind” concepts.

“Intrusion detection” is generally understood to refer to or to describe the ability of an information system to detect unauthorized actions performed by unauthorized entities. “Management of security” is generally understood to refer to or to describe the ability of an information system to maintain, configure, inspect, measure and/or monitor security aspects of an information system. “End-user's system protection” is generally understood to refer to or to describe the ability of an information system to provide security function for an end-user's computing device. For example, a personal firewall can provide some protection for unauthorized access to an end-user's computing device.

“Security standards and certifications” is generally understood to refer to or to describe the standards, laws or regulations that are required to do business in a particular area (e.g., practice and/or geographic region), or that are used to measure a “level” of security. Examples include the security provisions of the US Public Law “Health Insurance Portability and Accountability Act” (HIPAA) and “Common Criteria,” commercially available from National Information Assurance Partnership of Gaithersburg, Md.

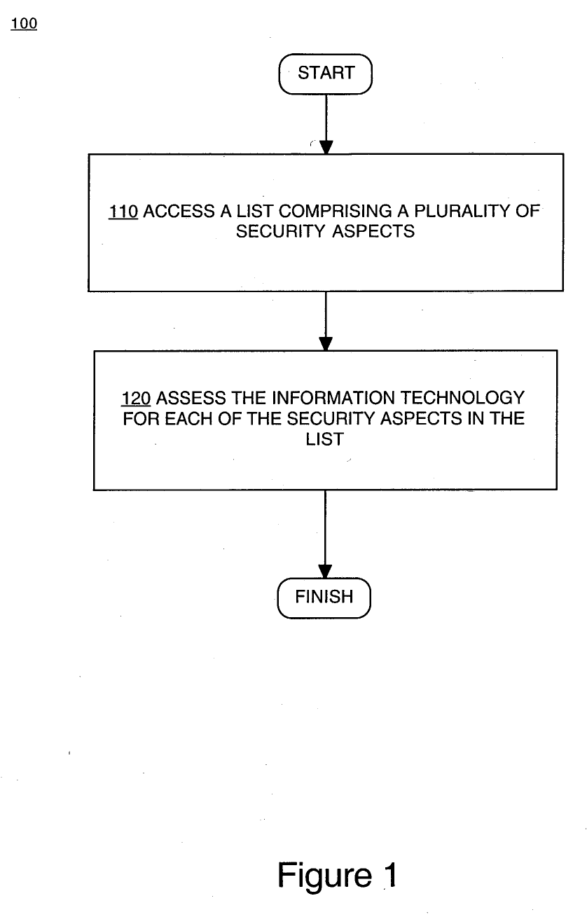

FIG. 1 illustrates a flow diagram of a method 100 of assessing security of information technology, in accordance with embodiments of the present invention. In block 110, a list comprising a plurality of security aspects is accessed. This list can comprise privacy, authentication, authorization, data integrity, confidentiality, non-repudiation, security audit, virus protection, perimeter security, intrusion detection, management of security, end-user's system protection and/or security standards and certifications. It is appreciated that such a list can contain other security aspects not listed above in accordance with embodiments of the present invention.

In block 120, the information technology, e.g., a solution, is assessed for each of the security aspects in the list.

Table 1, below, illustrates an exemplary list of security aspects for an exemplary banking solution. The exemplary banking solution is a new service offering whereby customers of a bank may conduct banking operations, e.g., check balances, transfer monies and the like, over mobile phones.

TABLE 1
Applicable Security Aspects of Solution

| | Acceptable |
|---|---|
| | Security? |
| Privacy | ? |
| Authentication | ? |
| Authorization | ? |
| Data Integrity | ? |
| Confidentiality | ? |
| Non-repudiation | ? |
| Security Audit | ? |
| Virus Protection | ? |
| Perimeter Security | ? |
| Intrusion Detection | ? |
| Management of Security | ? |
| End-user's system protection | ? |
| Security | |
| Standards and Certifications | ? |

To conduct wireless banking, it is generally necessary to transmit customer information, e.g., balances, account numbers and the like. In order to address the privacy aspect, a security technology, e.g., encryption, can be applied. Banking is typically highly regulated, so there will typically be regulatory requirements on the type and/or “strength” of encryption, e.g., triple data encryption standard (DES) with a 256-bit key. In addition, it can be necessary to store private information in an encrypted form on a mobile device. Further, it can be necessary to store private information in an encrypted form within the banking institution to prevent unauthorized access by insiders.

To address the authentication aspect of security, at least two authentications should be used. A first authentication of the user to the mobile unit and a second authentication of the user/mobile unit to the bank's information system are typical. Exemplary technologies for authentication may be found in the standards and methods of the Trusted Computing Platform Alliance (TCPA), commercially available from the Trusted Computing Platform Alliance of Hillsboro, Oreg. Another exemplary method is to require that mobile users change passwords on a regular basis.

To address the authorization aspect of security from the solution owner's, or solution developer's perspective, there are numerous technologies available. For many banking transactions, distinctions between authentication and authorization may blur. For example, if a customer is authenticated, then that customer is authorized to perform certain tasks, e.g., perform a balance inquiry. The authorization may be inherent in the solution. Netegrity TRANSACTIONMINDER™, commercially available from Netegrity of Waltham, Mass., is an example of a technology that can generally address authorization.

Data integrity is typically a very important security aspect in banking. There are numerous well-known methods and systems to provide various levels of data integrity.

Data confidentiality is typically important for banking transactions and there are numerous well-known methods and system to provide various levels of data confidentiality. An exemplary technology is the Data Encryption Standard (DES).

Non-repudiation generally represents or describes an ability or procedure to document an event such that it can't be denied. This is generally very important in banking transactions. Non-repudiation can be addressed through the maintenance of transaction logs in a persistent, non-modifiable media along with a time stamp from a secure time server. Additionally, public key/private key infrastructure systems can be used to “digitally sign” a document to provide certification that a communication originated with a particular entity.

In order to address a security audit aspect of security, a facility that can be audited should be created. Correlation of geographically and temporally diverse actions is desirable.

Virus protection is generally a well-known security aspect, and there are numerous well-known commercially available products to address a range of protection levels against viruses and other “infectious” computer software. Virus protection may generally be broken down into three areas: protection, detection and recovery. Protection refers to an ability to keep “infectious” computer software from being installed on a computer system. Detection refers to an ability to discover “infectious” computer software, e.g., when stored and/or when operating on a computer system. Recover refers to an ability to terminate malicious actions by “infectious” computer software and/or to mitigate damage done by such software.

Perimeter security is often addressed by technologies such as firewalls and/or routers. Intrusion detection can be implemented by a variety of well-known network intrusion detection systems.

An aspect of management of security is how to translate a security policy into actions, e.g., a specific configuration in a firewall device. For example, customers wishing to conduct certain “high level” transactions, e.g., a stock trade, may be required to operate a particular anti-virus software on their systems.

Security standards and certifications addresses standards, laws and/or regulations that are required to conduct a specific type of business, e.g., banking.

Method 100 can be beneficially applied to portions of a solution during at least three stages of a development process. During a design phase, all aspects should be assessed or evaluated against a list of desirable security aspects in order to determine if a desirable level of security is, or can be, achieved in the proposed design. If so indicated, a solution design can be revised to improve one or more security aspects. Typically, it is less costly in terms of design costs and schedule impacts to address security during a design phase.

During a test phase, security aspects should again be evaluated using the same list of security aspects, e.g., the list of Table 1, above. Typically, it is less costly to detect and correct security problems in testing than after a solution is deployed. Exemplary testing can include penetration testing and security source-code scanners.

During the implementation of a solution, it is beneficial to evaluate security again. Real customer actions in combination with real data and interactions with other systems may illustrate differences in behavior between the implemented solution and a test environment. Conducting such a security evaluation early in the deployment can allow for early intervention and mitigation of any security problems.

Security aspects of a solution, e.g., the exemplary mobile banking described herein above, should be evaluated, or audited, on a regular basis, e.g., annually. Technologies, systems, regulations and security threats change. It is prudent to periodically review a solution during the solution's deployed life in order to detect and/or anticipate security problems.

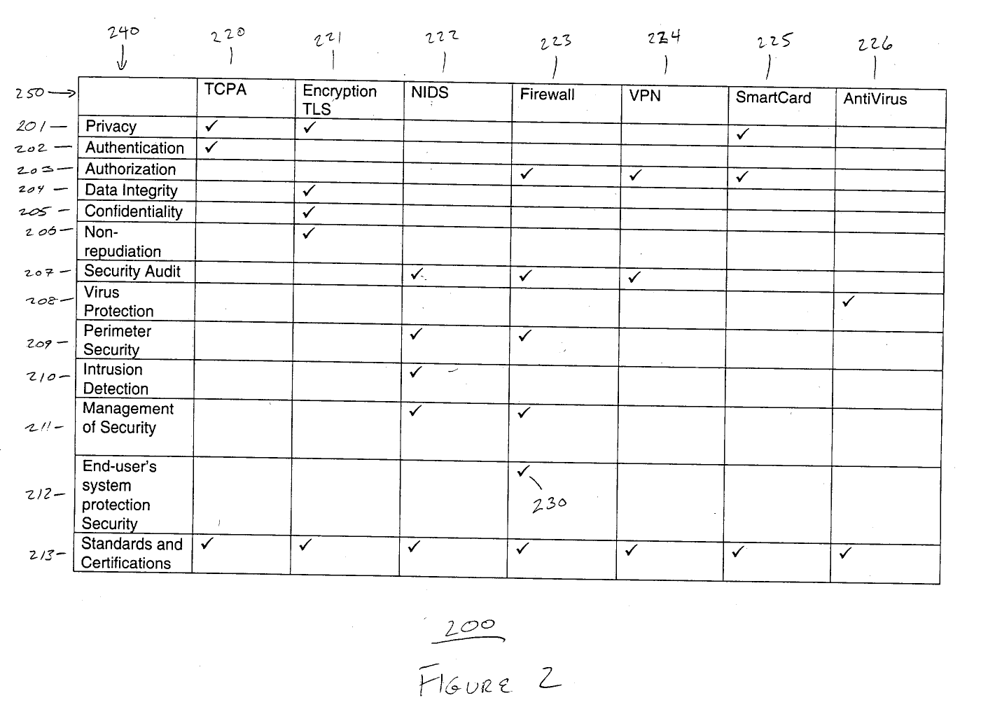

FIG. 2 illustrates a chart 200 of security aspects along with exemplary security technologies that can, in some cases, address the corresponding aspects of security for information technologies, in accordance with embodiments of the present invention. Column 240 of chart 200 lists 13 aspects of security. Row 250 of chart 200 lists seven exemplary security technologies. Checkmarks, e.g., checkmark 230, in a box at the intersection of a row and a column indicate that a particular exemplary technology can, in some cases, address the security aspect for that row. For example, checkmark 230 indicates that a firewall implementation can be used to implement security protection for end-user's systems.

Still referring to FIG. 2, columns 220-226 of chart 200 identify a variety of exemplary security technologies that can be applied to a solution to address particular aspects of security. Column 220 of chart 200 indicates some aspects of security for which the standards and methods of the Trusted Computing Platform Alliance (TCPA) can be applicable.

Column 221 of chart 200 indicates some aspects of security for which well-known systems and methods of encryption can be applicable. Column 222 of chart 200 indicates some aspects of security for which well-known systems and methods of network intrusion detection can be applicable.

Column 223 of chart 200 indicates some aspects of security for which well-known firewall implementations can be applicable. Column 224 of chart 200 indicates some aspects of security for which well-known virtual private networking implementations can be applicable.

Column 225 of chart 200 indicates some aspects of security for which the systems and methods known generally as smartcards can be applicable. Column 226 of chart 200 indicates some aspects of security for which well-known anti-virus software can be applicable.

Row 201 of chart 200 represents a privacy aspect of security for an information technology. Privacy is generally understood to refer to or to describe the ability of an information system (hardware, software or in combination) to control disclosure, transfer and/or modification of data. As indicated by corresponding checkmarks within row 201 of chart 200, a privacy aspect of security can be addressed by a number of different exemplary security technologies, e.g., TCPA, encryption and/or smartcards.

Row 202 of chart 200 represents an authentication aspect of security for an information technology. Authentication is generally understood to refer to or to describe the ability of a system to verify an identity. For example, the identity may be that of an individual user, a computer system, an application and/or a data set. As indicated by a corresponding checkmark within row 202 of chart 200, an authentication aspect of security can be addressed by exemplary security technology TCPA.

Row 203 of chart 200 represents an authorization aspect of security for an information technology. Authorization is generally understood to refer to the ability of an information system to grant permission, e.g., to access the system, based on an identity. As indicated by corresponding checkmarks within row 203 of chart 200, an authorization aspect of security can be addressed by a number of different exemplary security technologies, e.g., firewall implementations, virtual private networks (VPN) and smartcards.

Row 204 of chart 200 represents a data integrity aspect of security for an information technology. Data Integrity is generally understood to refer to or to describe the ability of an information system to control modification and/or deletion of data. As indicated by a corresponding checkmark within row 204 of chart 200, a data integrity aspect of security can be addressed by exemplary security technology of encryption.

Row 205 of chart 200 represents a confidentiality aspect of security for an information technology. Confidentiality is generally understood to refer to or to describe the ability of an information system to limit information distribution to approved entities only. As indicated by a corresponding checkmark within row 205 of chart 200, a confidentiality aspect of security can be addressed by exemplary security technology of encryption.

Row 206 of chart 200 represents a non-repudiation aspect of security for an information technology. Non-repudiation is generally understood to refer to or to describe the ability of an information system to document an event, e.g., a transfer of funds, in such a way that the occurrence of the event can not be denied. As indicated by a corresponding checkmark within row 206 of chart 200, a non-repudiation aspect of security can be addressed by exemplary security technology of encryption.

Row 207 of chart 200 represents a security audit aspect of security for an information technology. Security audit is generally understood to refer to or to describe a procedure to document events of an information system in a persistent record that can not be altered or deleted. As indicated by corresponding checkmarks within row 207 of chart 200, a security audit aspect of security can be addressed by a number of different exemplary security technologies, e.g., firewall implementations, virtual private networks (VPN) and Network Intrusion Detection Systems (NIDS).

Row 208 of chart 200 represents a virus protection aspect of security for an information technology. Virus protection is generally understood to refer to or to describe the ability of an information system to protect against, detect and recover from computer viruses. As indicated by a corresponding checkmark within row 208 of chart 200, a virus protection aspect of security can be addressed by exemplary security technology of anti-virus software.

Row 209 of chart 200 represents a perimeter security aspect of security for an information technology. Perimeter security is generally understood to refer to or to describe features of an information system, e.g., hardware and/or software, that provide “fence-like” security. As indicated by corresponding checkmarks within row 209 of chart 200, a perimeter security aspect of security can be addressed by a number of different exemplary security technologies, e.g., firewall implementations and Network Intrusion Detection Systems (NIDS).

Row 210 of chart 200 represents an intrusion detection aspect of security for an information technology. Intrusion detection is generally understood to refer to or to describe the ability of an information system to detect unauthorized actions performed by unauthorized entities. As indicated by a corresponding checkmark within row 210 of chart 200, an intrusion detection aspect of security can be addressed by exemplary security technology of NIDS.

Row 211 of chart 200 represents a management of security aspect of security for an information technology. Management of security is generally understood to refer to or to describe the ability of an information system to maintain, configure, inspect, measure and/or monitor security aspects of an information system. As indicated by corresponding checkmarks within row 211 of chart 200, a management of security aspect of security can be addressed by a number of different exemplary security technologies, e.g., firewall implementations and Network Intrusion Detection Systems (NIDS).

Row 212 of chart 200 represents an end-user's system protection aspect of security for an information technology. End-user's system protection is generally understood to refer to or to describe the ability of an information system to provide security function for an end-user's computing device. For example, a personal firewall can provide some protection for unauthorized access to an end-user's computing device. As indicated by a corresponding checkmark within row 212 of chart 200, an end-user's system protection aspect of security can be addressed by exemplary security technology of firewall implementations.

Row 213 of chart 200 represents a security standards and certifications aspect of security for an information technology. Security standards and certifications is generally understood to refer to or to describe the standards, laws or regulations that are required to do business in a particular area (e.g., practice and/or geographic region), or that are used to measure a “level” of security. Examples include the security provisions of the US Public Law Health Insurance Portability and Accountability Act (HIPPA) and “Common Criteria,” commercially available from National Information Assurance Partnership of Gaithersburg, Md. In general, all security technologies can be affected such standards and certifications.

Embodiments of the present invention provide for a method to assess information technology security. Further embodiments of the present invention meet the previously identified need in a manner that is complimentary and compatible with conventional computer system management techniques.

Embodiments in accordance with the present invention, assessing security of information technology, are thus described. While the present invention has been described in particular embodiments, it should be appreciated that the present invention should not be construed as limited by such embodiments, but rather construed according to the below claims.

What is claimed is:

1. A method of assessing security of information technology, said method comprising:
accessing a list comprising a plurality of security aspects; and
assessing said information technology for each of said security aspects in said list.

2. The method of claim 1 wherein said list comprises a privacy security aspect.

3. The method of claim 1 wherein said list comprises an authentication security aspect.

4. The method of claim 1 wherein said list comprises an authorization security aspect.

5. The method of claim 1 wherein said list comprises a data integrity security aspect.

6. The method of claim 1 wherein said list comprises a confidentiality security aspect.

7. The method of claim 1 wherein said list comprises a non-repudiation aspect.

8. The method of claim 1 wherein said list comprises a security audit security aspect.

9. The method of claim 1 wherein said list comprises a virus protection security aspect.

10. The method of claim 1 wherein said list comprises a perimeter security aspect.

11. The method of claim 1 wherein said list comprises an intrusion detection security aspect.

12. The method of claim 1 wherein said list comprises a management of security aspect.

13. The method of claim 1 wherein said list comprises an end-user's system protection security aspect.

14. The method of claim 1 wherein said list comprises a security standards and certifications security aspect.

15. The method of claim 1 wherein said list comprises a multiplicity of security aspects.

16. A method of developing a solution for operation on an information technology system, said method comprising:
accessing a list comprising a plurality of security aspects; and
developing each portion of said solution to achieve an acceptable level of security corresponding to each item on said list.

17. The method of claim 16 wherein said list comprises a privacy security aspect.

18. The method of claim 16 wherein said list comprises a authentication security aspect.

19. The method of claim 16 wherein said list comprises a authorization security aspect.

20. The method of claim 16 wherein said list comprises a data integrity security aspect.

21. The method of claim 16 wherein said list comprises a confidentiality security aspect.

22. The method of claim 16 wherein said list comprises a non-repudiation aspect.

23. The method of claim 16 wherein said list comprises a security audit security aspect.

24. The method of claim 16 wherein said list comprises a virus protection security aspect.

25. The method of claim 16 wherein said list comprises a perimeter security aspect.

26. The method of claim 16 wherein said list comprises an intrusion detection security aspect.

27. The method of claim 16 wherein said list comprises a management of security aspect.

28. The method of claim 16 wherein said list comprises an end-user's system protection security aspect.

29. The method of claim 16 wherein said list comprises a security standards and certifications security aspect.

30. The method of claim 16 wherein said list comprises a multiplicity of security aspects.
